(19) United States
(12) Patent Application Publication
(10) Pub. No.: US 2026/0183702 A1
(43) Pub. Date: Jul. 2, 2026

(54) MEMBRANES FOR CO2 CAPTURE

(71) Applicant: The Research Foundation for The State University of New York, Amherst, NY (US)

(72) Inventors: Miao YU, Pittsford, NY (US); Fan WANG, Williamsville, NY (US)

(21) Appl. No.: 19/130,379

(22) PCT Filed: Nov. 15, 2023
(86) PCT No.: PCT/US2023/079922

§ 371 Date: May 15, 2025

Related U.S. Application Data
(60) Provisional application No. 63/383,874, filed on Nov. 15, 2022.

(51) Int. Cl. B01D 53/22; B01D 67/00; B01D 69/02; B01D 69/08; B01D 71/02; B01D 71/68

(52) U.S. Cl. CPC B01D 53/228; B01D 67/00793; B01D 69/02; B01D 69/08; B01D 71/0211; B01D 71/0212; B01D 71/68; B01D 2053/224; B01D 2257/504; B01D 2325/02832; B01D 2325/02833

(57) ABSTRACT

Provided are articles and membranes, which may be functional membranes, that address the limitations of membranes known in the art. The membranes can be formed from porous substrates, carbon nanotubes, CO₂-philic components, and quantum dots and provide much higher selectivity than other membranes previously reported, which is at least an order of magnitude higher than commercial membranes, and thus can enrich CO₂ from 4% to 97% in one step. Also, the membranes of the present disclosure are stable under high vacuum operation and can maintain high CO₂ separation performance for at least 100 hours. For example, highly permeable membranes or highly selective membranes can be obtained by manipulating nano-confined frameworks and active CO₂-philic components.

### CROSS REFERENCE TO RELATED APPLICATIONS

This application claims the benefit of priority to U.S. Provisional Application No. 63/383,874, filed on Nov. 15, 2022, the disclosure of which is incorporated herein by reference.

### STATEMENT REGARDING FEDERALLY SPONSORED RESEARCH

This invention was made with government support under grant no. DE-FE0031598 awarded by the Department of Energy. The government has certain rights in the invention.

### BACKGROUND OF THE DISCLOSURE

Up to 2020, 80% of US energy consumption derives from the combustion of fossil fuel including coal, petroleum, and natural gas, resulting in over 35 billion tons of CO₂ emissions to atmosphere every year. DOE launched the carbon capture and storage (CCS) program to enable cost-effective implementation of carbon capture technologies. Solvent absorption is one of the mature technologies to capture CO₂ in the early stage. However, high energy consumption of this technology limits its further development in the future. For natural gas flue gas treatment, membranes with high CO₂/N₂ selectivity are required to perform highly efficient separation. Currently, most gas separation membranes available on the market show limited CO₂/N₂ selectivity and are unable to separate CO₂ in a highly efficient way. Further, membranes developed in laboratory encounter stability and scaling up issues that restrict further application under practical operation conditions.

### SUMMARY OF THE DISCLOSURE

The present disclosure provides articles and membranes, which may be nano-confined functional membranes, that address the limitations of membranes known in the art. Uniform and stable membranes (e.g., nano-confined functional membranes) can be grown on the frameworks (e.g., nano-confined framework) and provide much higher selectivity than other membranes previously reported, which is at least an order of magnitude higher than commercial membranes, and thus can enrich CO₂ from 4% to 97% in one step. Also, membranes of the present disclosure are stable under high vacuum operation and can maintain high CO₂ separation performance for at least 100 hours. Furthermore, the fabrication process is simple and can be applied to membrane scaling up in industrial field. Finally, separation performance of the membranes and articles (e.g., nano-confined functional membranes) can be tuned via adjusting the composition of active components in the nano-confined framework, thus allowing flexibility and tailored properties for a specific industrial application. For example, highly permeable membrane or highly selective membrane can be obtained by manipulating nano-confined framework and active CO₂-philic components.

In an aspect, the present disclosure provides an article for CO₂ and/or N₂ capture.

The article may comprise a porous substrate having a plurality of carbon nanotubes disposed thereon, wherein the plurality of carbon nanotubes are infiltrated (e.g., coated) with (i) a CO₂-philic component and (ii) one or more nitrogen-doped graphene oxide quantum dots (N-GOQDs). The porous substrate having a plurality of carbon nanotubes disposed thereon, wherein the plurality of carbon nanotubes are infiltrated (e.g., coated) with (i) a CO₂-philic component and (ii) one or more nitrogen-doped graphene oxide quantum dots (N-GOQDs) may be referred to as a “membrane.” The porous substrate having a plurality of carbon nanotubes disposed thereon may be referred to as a “framework.” An article may comprise the membrane.

In an aspect, the present disclosure provides a method for making a membrane for CO₂ and/or N₂ capture.

The method may comprise contacting a porous substrate with a plurality of carbon nanotubes; applying a negative pressure (e.g., vacuum) to the porous substrate; drying the carbon nanotube-coated porous substrate; contacting the carbon nanotube-coated porous substrate with a reaction mixture comprising a plurality of nitrogen-doped graphene oxide quantum dots (N-GOQDs) and a CO₂-philic component; and heating the carbon nanotube-coated porous substrate that has been contacted with the plurality of N-GOQDs and the CO₂-philic component, wherein the membrane is formed.

In an aspect, the present disclosure provides a method for using an article and/or membrane of the present disclosure. An article and/or membrane may be used to capture CO₂ and/or N₂ gas.

A method of using may comprise contact a gas with an article or membrane of the present disclosure. The gas may be or comprise CO₂ and/or N₂. In various examples, the article or membrane has a selectivity to selectively capture CO₂ rather than other gases.

### BRIEF DESCRIPTION OF THE FIGURES

For a fuller understanding of the nature and objects of the disclosure, reference should be made to the following detailed description taken in conjunction with the accompanying figures.

FIG. 1. A chart showing U.S. energy consumption in 2019.

FIG. 2. A chart showing CO₂ emissions by fuel type across the world.

FIG. 3. A chart comparison of various CO₂ absorption methods.

FIG. 4. Cartoons comparing various absorption materials.

FIG. 5. Cartoons comparing various absorption materials.

FIG. 6. A cartoon showing the membrane of the present disclosure.

FIG. 7. (a) Schematic of a nanoconfined functional membrane composed of single wall carbon nanotube (SWCNT), Nitrogen-doped graphene oxide quantum dot (N-GOQD) and CO₂-philic agent; (b) (c) cross-section and surface images of SWCNT mesh on PES support; (d) (e) cross-section and surface images of our nanoconfined functional membrane.

FIG. 8. A schematic comparing a previously known method and a method of making of the present disclosure.

FIG. 9. A schematic of the method of the present

FIG. 10. Comparison of the CO₂ separation performance with facilitated transport membranes (FTMs) and nanoconfined composite membrane (Left); Long-term stability of our specific-designed nanoconfined functional membrane (Right).

FIG. 11. Comparison of the CO₂ separation performance with facilitated transport membranes (FTMs) and nanoconfined composite membrane (Left); Long-term stability of our specific-designed nanoconfined functional membrane (Right).

FIG. 12. CO₂ separation performance of NCIL membrane with different feed pressure (Left) and permeate pressure (Right).

FIG. 13. Comparison of the CO₂ separation performance of nanoconfined functional hollow fiber membrane before and after applying circulation coating method (Left); Demonstration of 1000 cm² hollow fiber membrane module (Right).

FIG. 14. Left: Improved carbon nanotube (CNT) uniformity onto PES support along axial direction after applying second generation coating technique; Right: Improved NCIL membrane reproducibility after applying second generation coating technique.

FIG. 15. Top: method flow chart for a conventional coating method (100). Bottom: line drawing showing the schematic for a conventional coating method showing the system for coating the porous substrate (10), porous substrate (11), syringe pump loaded with water (12), vacuum pump (13), carbon nanotube mixture (14), and valves (1A and 1B).

FIG. 16. Top: method flow chart for circulation coating method (200). Bottom: line drawing showing the schematic for a circulation coating method showing the system for coating the porous substrate (20), porous substrate (21), circulation pump (22), vacuum pump (23), carbon nanotube mixture (24), and valves (2A, 2B, and 2C).

FIG. 17. Top: method flow chart for one-step vacuum filtration method (300). Bottom: line drawing showing the schematic for a one-step vacuum filtration method showing the system for coating the porous substrate (30), porous substrate (31), water pump (32), vacuum pump (33), carbon nanotube mixture (34), syringe pump loaded with carbon nanotube mixture (35), and valves (3A, 3B, and 3C).

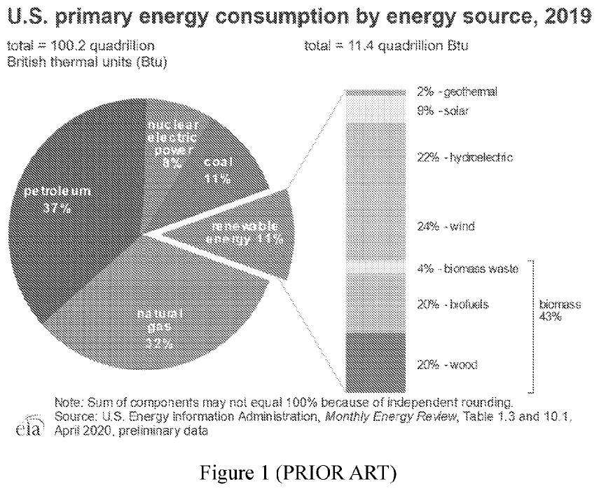

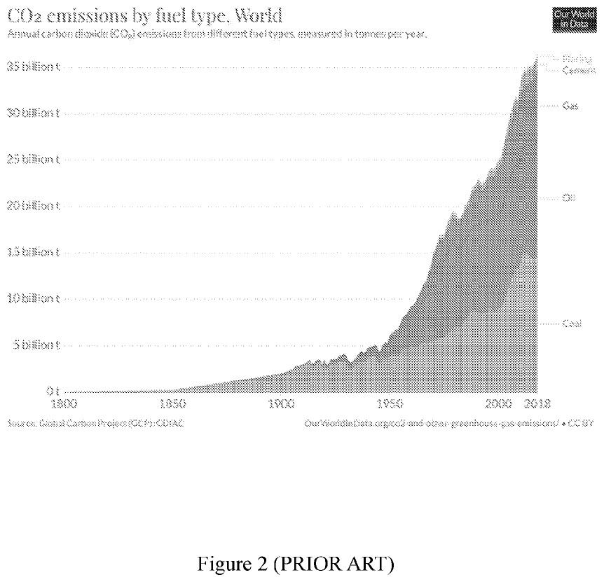

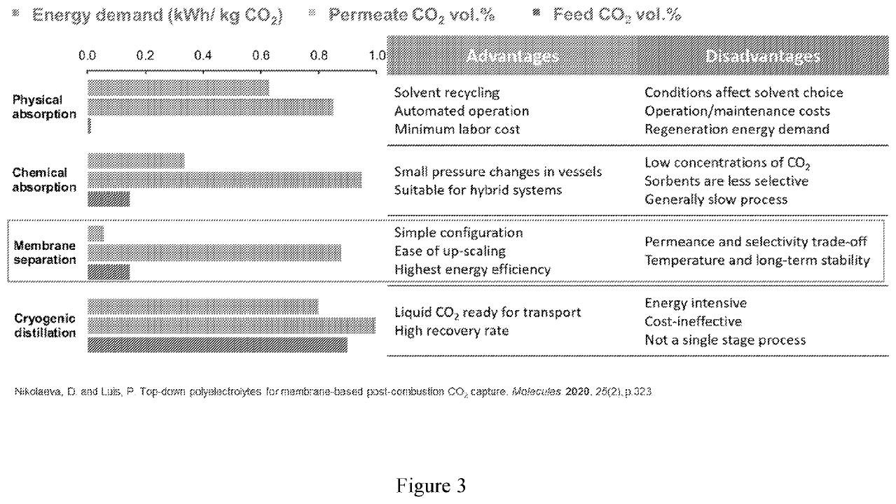

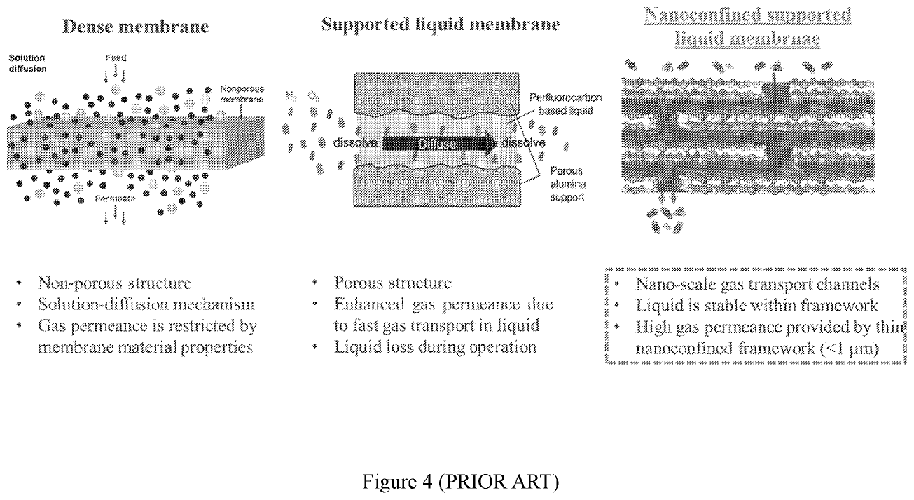

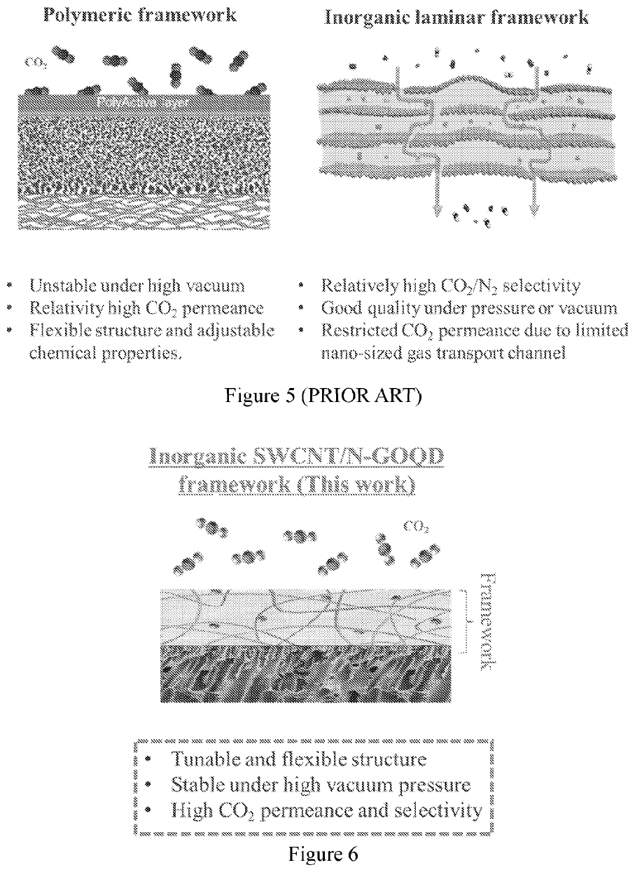

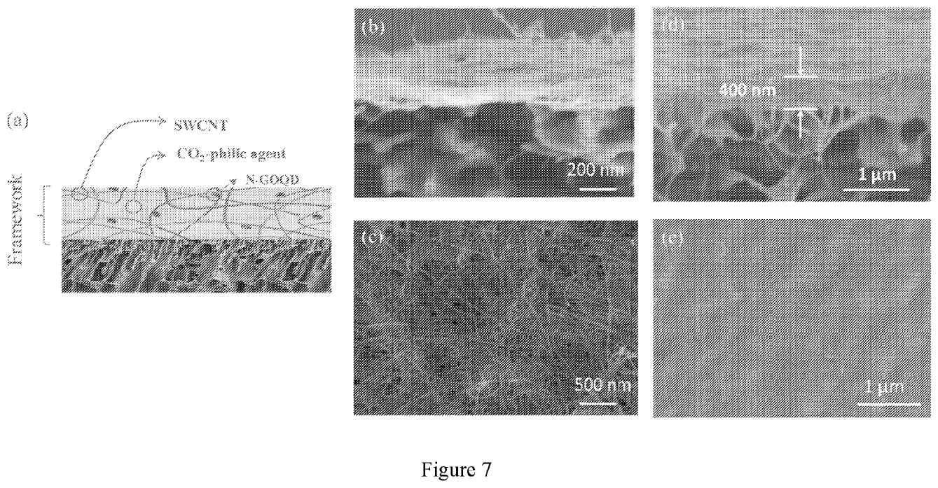

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, and process step changes may be made without departing from the scope of the disclosure.

As used herein, unless otherwise indicated, “about”, “substantially”, or “the like”, when used in connection with a measurable variable (such as, for example, a parameter, an amount, a temporal duration, or the like) or a list of alternatives, is meant to encompass variations of and from the specified value including, but not limited to, those within experimental error (which can be determined by, e.g., a given data set, an art accepted standard, etc. and/or with, e.g., a given confidence interval (e.g. 90%, 95%, or more confidence interval from the mean), such as, for example, variations of +/−10% or less, +/−5% or less, +/−1% or less, and +/−0.1% or less of and from the specified value), insofar such variations in a variable and/or variations in the alternatives are appropriate to perform in the instant disclosure. As used herein, the term “about” may mean that the amount or value in question is the exact value or a value that provides equivalent results or effects as recited in the claims or taught herein. That is, it is understood that amounts, sizes, compositions, parameters, and other quantities and characteristics are not and need not be exact, but may be approximate and/or larger or smaller, as desired, reflecting tolerances, conversion factors, rounding off, measurement error, or the like, or other factors known to those of skill in the art such that equivalent results or effects are obtained. In general, an amount, size, composition, parameter, or other quantity or characteristic, or alternative is “about” or “the like,” whether or not expressly stated to be such. It is understood that where “about,” is used before a quantitative value, the parameter also includes the specific quantitative value itself, unless specifically stated otherwise.

Ranges of values are disclosed herein. The ranges set out a lower limit value and an upper limit value. Unless otherwise stated, the ranges include the lower limit value, the upper limit value, and all values between the lower limit value and the upper limit value, including, but not limited to, all values to the magnitude of the smallest value (either the lower limit value or the upper limit value) of a range. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “0.1% to 5%” should be interpreted to include not only the explicitly recited values of 0.1% to 5%, but also, unless otherwise stated, include individual values (e.g., 1%, 2%, 3%, and 4%) and the sub-ranges (e.g., 0.5% to 1.1%; 0.5% to 2.4%; 0.5% to 3.2%, and 0.5% to 4.4%, and other possible sub-ranges) within the indicated range. It is also understood (as presented above) that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about, it will be understood that the particular value forms a further disclosure. For example, if the value “about 10” is disclosed, then “10” is also disclosed.

As used herein, unless otherwise stated, the term “group” refers to a chemical entity that is monovalent (i.e., has one terminus that can be covalently bonded to other chemical species), divalent, or polyvalent (i.e., has two or more termini that can be covalently bonded to other chemical species). The term “group” also includes radicals (e.g., monovalent and multivalent, such as, for example, divalent radicals, trivalent radicals, and the like). Illustrative examples of groups include:

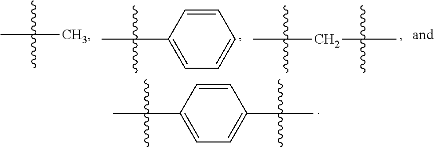

As used herein, unless otherwise indicated, the term “aliphatic group” refers to branched or unbranched hydrocarbon groups that, optionally, contain one or more degrees of unsaturation. Degrees of unsaturation include, but are not limited to, alkenyl groups, alkynyl groups, and aliphatic cyclic groups. For example, the aliphatic groups are a C₁ to C₂₀ aliphatic group, including all integer numbers of carbons and ranges of numbers of carbons therebetween (e.g., C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, and C₂₀). The aliphatic group may be unsubstituted or substituted with one or more substituent. Examples of substituents include, but are not limited to, halogens (—F, —Cl, —Br, and —I), aliphatic groups (e.g., alkyl groups, alkenyl groups, alkynyl groups, and the like), halogenated aliphatic groups (e.g., trifluoromethyl group and the like), aryl groups, halogenated aryl groups, alkoxide groups, amine groups, nitro groups, carboxylate groups, carboxylic acids, ether groups, alcohol groups, alkyne groups (e.g., acetylenyl groups and the like), and the like, and combinations thereof. Groups that are aliphatic may be alkyl groups, alkenyl groups, alkynyl groups, or carbocyclic groups, and the like.

As used herein, unless otherwise indicated, the term “alkyl group” refers to branched or unbranched saturated hydrocarbon groups. Examples of alkyl groups include, but are not limited to, methyl groups, ethyl groups, propyl groups, butyl groups, isopropyl groups, tert-butyl groups, and the like. For example, the alkyl group is C₁ to C₂₀, including all integer numbers of carbons and ranges of numbers of carbons therebetween (e.g., C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, and C₂₀). The alkyl group may be unsubstituted or substituted with one or more substituent. Examples of substituents include, but are not limited to, various substituents such as, for example, halogens (—F, —Cl, —Br, and —I), aliphatic groups (e.g., alkyl groups, alkenyl groups, alkynyl groups, and the like), aryl groups, alkoxide groups, carboxylate groups, carboxylic acids, ether groups, amine groups, and the like, and combinations thereof.

As used herein, unless otherwise indicated, the term “aryl group” refers to C₅ to C₃₀ aromatic or partially aromatic carbocyclic groups, including all integer numbers of carbons and ranges of numbers of carbons therebetween (e.g., C₅, C₆, C₇, C₈, C₉, C₁₀, C₁₁, C₁₂, C₁₃, C₁₄, C₁₅, C₁₆, C₁₇, C₁₈, C₁₉, C₂₀, C₂₁, C₂₂, C₂₃, C₂₄, C₂₅, C₂₆, C₂₇, C₂₈, C₂₉, and C₃₀). An aryl group may also be referred to as an aromatic group. The aryl groups may comprise polyaryl groups such as, for example, fused ring, biaryl groups, or a combination thereof. The aryl group may be unsubstituted or substituted with one or more substituent. Examples of substituents include, but are not limited to, substituents such as, for example, halogens (—F, —Cl, —Br, and —I), aliphatic groups (e.g., alkyl groups, alkenyl groups, alkynyl groups, and the like), aryl groups, alkoxides, carboxylates, carboxylic acids, ether groups, and the like, and combinations thereof. Aryl groups may contain hetero atoms, such as, for example, nitrogen (e.g., pyridinyl groups and the like). Examples of aryl groups include, but are not limited to, phenyl groups, biaryl groups (e.g., biphenyl groups and the like), fused ring groups (e.g., naphthyl groups and the like), hydroxybenzyl groups, tolyl groups, xylyl groups, furanyl groups, benzofuranyl groups, indolyl groups, imidazolyl groups, benzimidazolyl groups, pyridinyl groups, and the like.

The present disclosure provides articles and membranes, which may be nano-confined functional membranes, that address the limitations of membranes known in the art. Uniform and stable membranes (e.g., nano-confined functional membranes) can be grown on the frameworks (e.g., nano-confined framework) and provide much higher selectivity than other membranes previously reported, which is at least an order of magnitude higher than commercial membranes, and thus can enrich CO₂ from 4% to 97% in one step. Also, membranes of the present disclosure are stable under high vacuum operation and can maintain high CO₂ separation performance for at least 100 hours. Furthermore, the fabrication process is simple and can be applied to membrane scaling up in industrial field. Finally, separation performance of the membranes and articles (e.g., nano-confined functional membranes) can be tuned via adjusting the composition of active components in the nano-confined framework, thus allowing flexibility and tailored properties for a specific industrial application. For example, highly permeable membrane or highly selective membrane can be obtained by manipulating nano-confined framework and active CO₂-philic components.

In an aspect, the present disclosure provides an article for CO₂ and/or N₂ capture.

The article may comprise a porous substrate having a plurality of carbon nanotubes disposed thereon, wherein the plurality of carbon nanotubes is infiltrated (e.g., coated) with (i) a CO₂-philic component and (ii) one or more quantum dots. The porous substrate having a plurality of carbon nanotubes disposed thereon, wherein the plurality of carbon nanotubes is infiltrated (e.g., coated) with (i) a CO₂-philic component and (ii) one or more quantum dots may be referred to as a “membrane” or “framework” An article may comprise the membrane/framework.

The major advantages of the articles, membranes, and frameworks of the present disclosure over current CO₂ capture membranes are as follows:
1) High CO₂ permeance and high CO₂/N₂ selectivity: the frameworks of the present disclosure (e.g., carbon-based nano-confined frameworks) generate low transport resistance, compared with other nano-confined laminar frameworks (GO, MoS₂), thus providing a desirable platform for loading CO₂-philic agents for high permeance gas transport. Under the practical separation conditions, the membranes (e.g., nano-confined functional membranes) have CO₂/N₂ selectivity higher than 1,000, more than one order of magnitude higher than commercial membranes, such as Polaris membranes.
2) Stability: The membranes of the present disclosure (e.g., nano-confined functional membranes) are stable under low vacuum pressure and highly humid conditions and it is anticipated that they will not deform for at least 100 hours.
3) Scalability: The frameworks of the present disclosure (e.g., carbon-based nanoconfined framework) can be easily scaled up (from 10 cm² to 1000 cm²) by applying circulation coating method. Upon loading CO₂-philic agents, membranes (e.g., nano-confined functional membranes) showed comparable performance to small-area ones.
4) Tunable and flexible membrane structure: The frameworks of the present disclosure (e.g., nano-confined framework) can be tuned via adjusting single walled carbon nanotube (SWCNT) loading and quantum dot (e.g., N-GOQD) loading. As a result, the membranes (e.g., nano-confined functional membranes) can be tailored to be applied in a specific industrial application in a simple way.

Various porous substrates may be used in an article, membrane, and framework of the present disclosure. The porous substrate may be referred to as a substrate. For example, the substrate may be a fiber, such as, for example, a hollow fiber. In various examples, a porous substrate may be a polymer substrate. Examples of polymer substrates include, but are not limited to, polyether sulfone (PES), polyacrylonitrile (PAN), polyvinylidene difluoride (PVDF), and the like.

The porous substrates may have various features. For example, the porous substrate has a plurality of pores. The pores may be of various dimensions. For example, the pores may have a longest linear dimension of 10 to 50 nm, including all 0.1 nm values and ranges therebetween. In various examples, a PES substrate may have a range of pore sizes of 20 to 40 nm, including all 0.1 nm values and ranges therebetween. In various examples, when a PES substrate has a range of pore sizes of 20 to 40 nm, about 50% of the pores are about 30 nm.

The porous substrate has a plurality of carbon nanotubes disposed thereon. The disposed carbon nanotubes may be referred to as a mesh or layer disposed on the porous substrate. At least a portion of a surface of the porous substrate may have carbon nanotubes disposed thereon. The carbon nanotube loading density may be 30 to 100 mg/m², including all 0.1 mg/m² values and ranges between (e.g., the loading density of carbon nanotube load density may be around or be 60 mg/m²). For example, when the carbon nanotube loading density is or around 60 mg/m², the carbon nanotube layer may have a thickness of 100 to 200 nm, including every 0.1 nm values and ranges therebetween. The carbon nanotubes may be single walled carbon nanotubes. The single-wall carbon nanotubes may have a diameter of 2 to 3 nm, including all 0.01 nm values and ranges therebetween. The single-wall carbon nanotubes may have a longest linear dimension (e.g., length) of about 1 to 10 μm, including all integer nm values and ranges (e.g., the single wall carbon nanotubes may have a longest linear dimension (e.g., length) is or is about 5 μm). A carbon nanotube loading of or about 60 mg/m² may result in a defect free carbon nanotube layer.

The article, membrane, or framework may comprise various CO₂-philic components. For example, the article may comprise a plurality of CO₂-philic components that are the same or a plurality where at least a portion of the CO₂-philic components is different (e.g., the plurality of CO₂-philic components comprises two or more different CO₂-philic components). In various examples, the CO₂-philic components are derived from ionic liquids. Various ionic liquids may be used. An ionic liquid may be 1-ethyl-3-methylimidazolium acetate ([emim][Ac]) or 1-ethyl-3-methylimidazolium tetrafluoroborate ([emim][BF4]). For example, the ionic liquid may be an amino acid ionic liquid, such as, for example, 1-ethyl-3-methylimidazolium glycinate ([emim][Gly]) and the like. Other examples of suitable amino acid ionic liquids include, but are not limited to, [emim][Ala], [emim][Arg], [emim][Val], [emim][Lys], [emim][Pro], and the like. Combinations of any of the foregoing may be used.

In various other examples, the CO₂-philic components are amine compounds. Various amine compounds may be used. The amine compounds (which may be simply referred to as “amines”). The amines may be aliphatic amines or aryl amines. The amines may have two or more primary or secondary amino groups (e.g., two, three, four, or five). The mass of each amine compound may be less than or equal to 250 g/mol. In various examples, the amine compound comprises two primary amino groups. Examples of aliphatic amine compounds comprising two primary amino groups include, but are not limited to, ethylene diamine, 1,3-diamino propane, 1,4-diaminobutane, 1,5-diaminopentane, 1,6-diaminohexane, and the like. The sorbent may comprise any combination of any of the foregoing. In various other examples, the amine compound comprises three primary amino groups. Examples of aliphatic amine compounds comprising three primary amino groups include, but are not limited to, polypropylenimine tetramine dendrimer (DAB-Am-4), a PAMAM dendrimer, aliphatic amine compounds having the following structure:

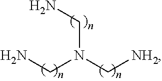

wherein n is 1, 2, 3, 4, or 5, and the like. The aliphatic amines may be alkyl amines. The article may comprise any combination of any of the foregoing. In various embodiments, the amine compound is:

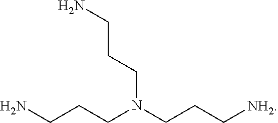 [SMILES: NCCCN(CCCN)CCCN]

The article, membrane/framework may comprise a plurality of the quantum dots. The plurality of quantum dots may one or more portions of quantum dots that are different than the remainder of the plurality. The quantum dots may be silicon or metal oxide quantum dots. For example, the quantum dots may be nitrogen-doped graphene oxide quantum dots (N-GOQDs). Without intending to be bound by any particular theory, it is considered that N-GOQDs exhibit p- and n-type conductivity. The quantum dots may have a longest linear dimension (e.g., diameter) of 1 to 10 nm, including all 0.1 nm values and ranges therebetween.

The article, membranes, and frameworks may be of various shapes and sizes. For example, the article may be a filter or a column packed or loaded with a membrane/framework of the present disclosure.

In an aspect, the present disclosure provides a method for making a membrane for CO₂ and/or N₂ capture.

Without intending to be bound by any particular theory, it is considered that the membrane of the present disclosure can selectively capture CO₂.

The method may comprise contacting a porous substrate with a plurality of carbon nanotubes; applying a negative pressure (e.g., vacuum) to the porous substrate; drying the carbon nanotube-coated porous substrate; contacting the carbon nanotube-coated porous substrate with a reaction mixture comprising a plurality of quantum dots (e.g., N-GOQDs) and one or more CO₂-philic component; and heating the carbon nanotube-coated porous substrate that has been contacted with the plurality of quantum dots (e.g., N-GOQDs) and the one or more CO₂-philic components, wherein the membrane is formed.

The carbon nanotubes may be contacted with the porous substrate in various ways. A mixture comprising carbon nanotubes (e.g., single walled carbon nanotubes) may be contacted with a porous substrate. The mixture may be a colloid, slurry, or suspension. The mixture may comprise a dispersant (e.g., polystyrene sulfonate), carbon nanotubes, and water. Various other dispersants are known in the art and may be used. Following application of the mixture, a negative pressure may be applied to the substrate having the mixture disposed thereon. The mixture may be disposed on any portion of a surface or all of a surface of the substrate or all surfaces of the substrate This step may be referred to as the “CNT coating step.”

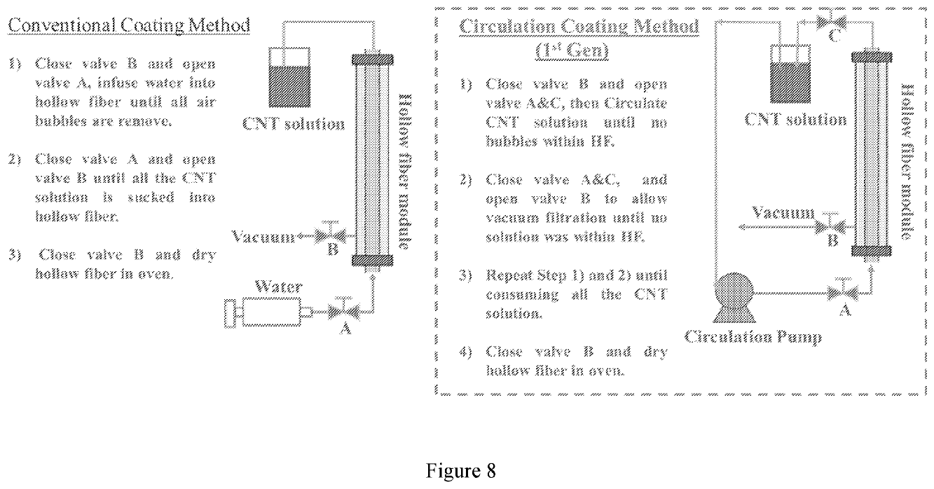

The CNT coating step may be performed in various ways. The CNT coating step of the present disclosure is different from conventional methods known in the art. See FIG. 8. For example, the CNT coating step is performed by passing a stream of a carbon nanotube mixture through the porous substrate (e.g., hollow fiber) with a circulation pump. See FIG. 8. This process may be referred to as a circulation coating step.

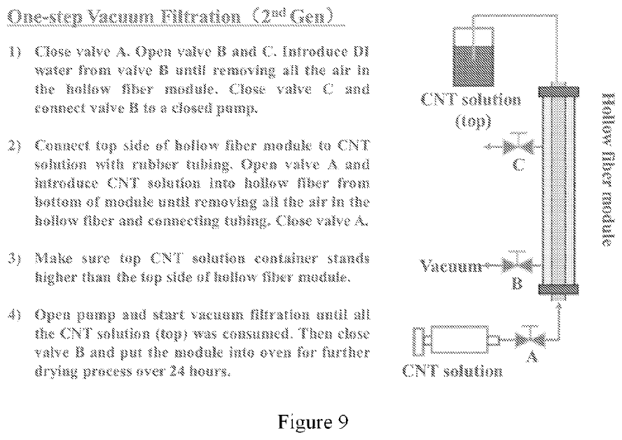

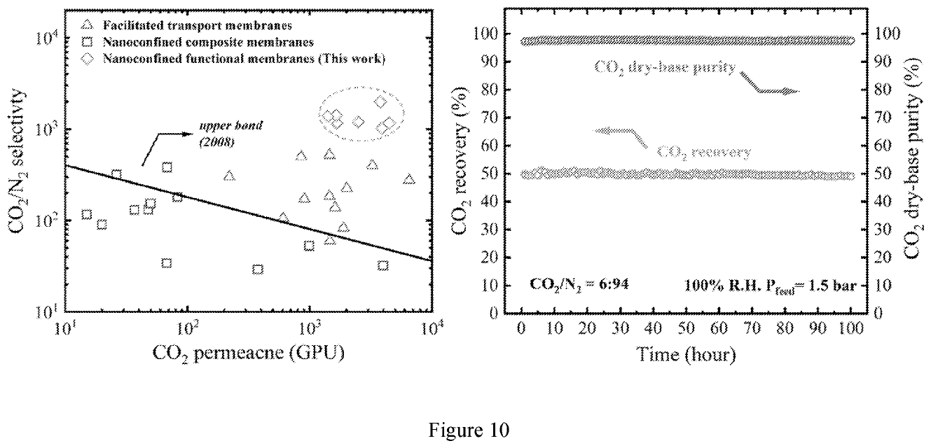

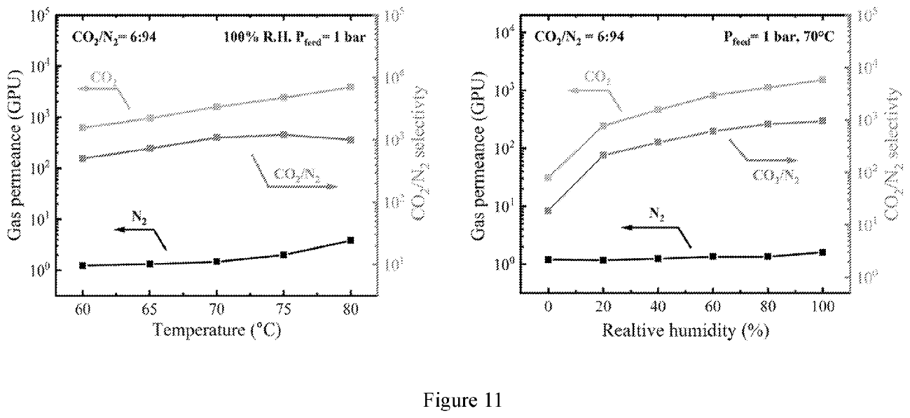

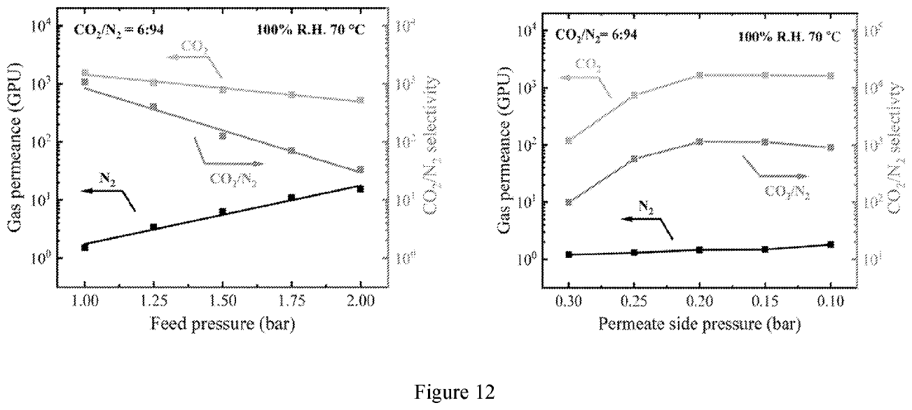

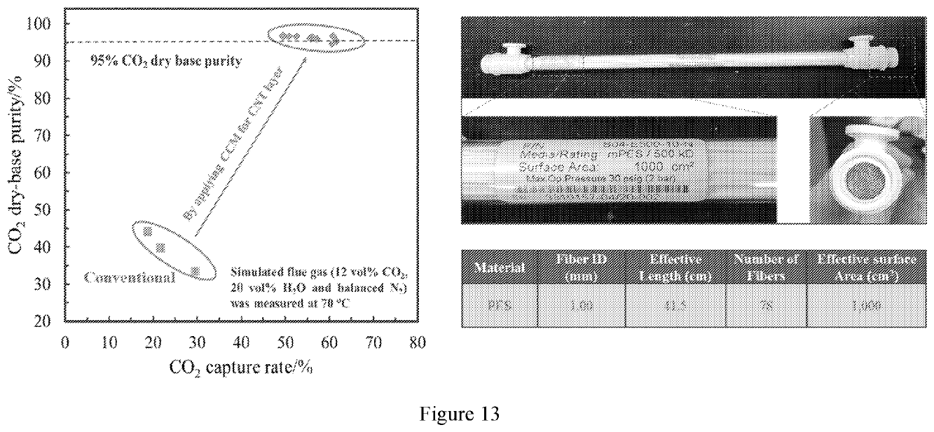

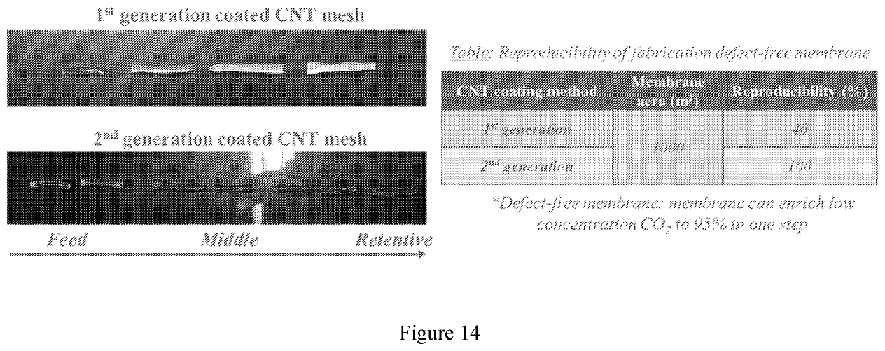

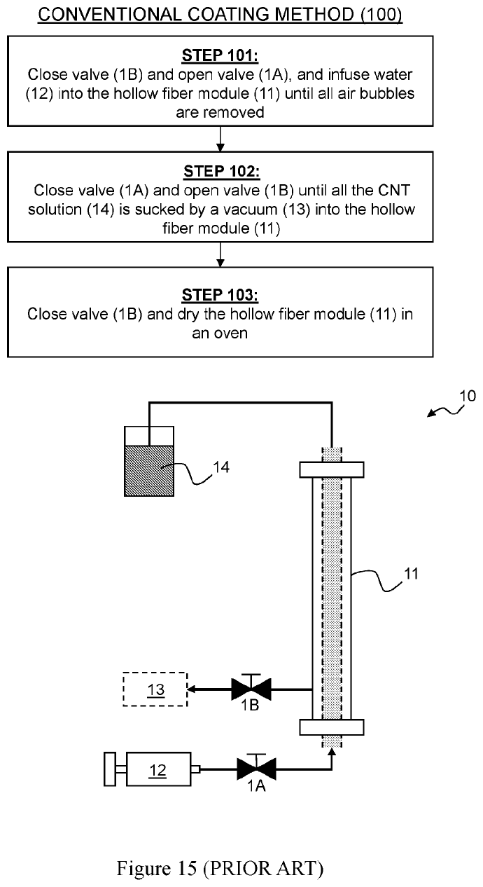

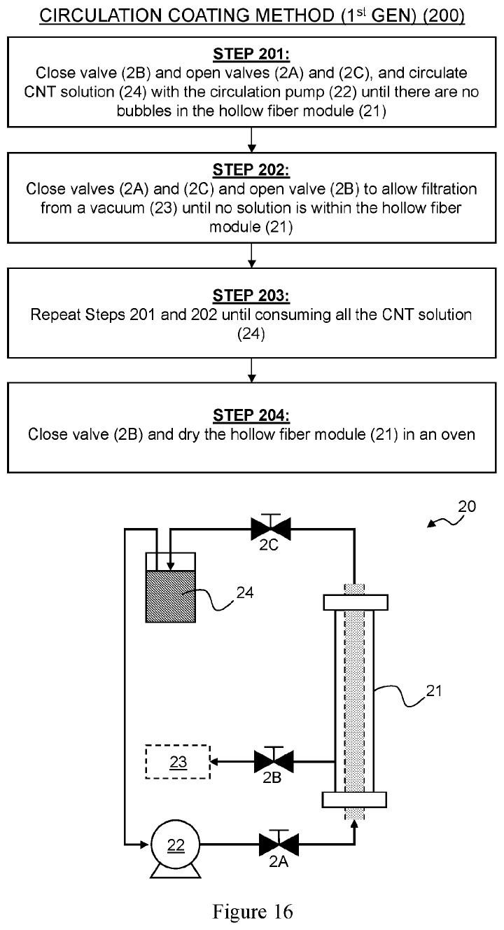

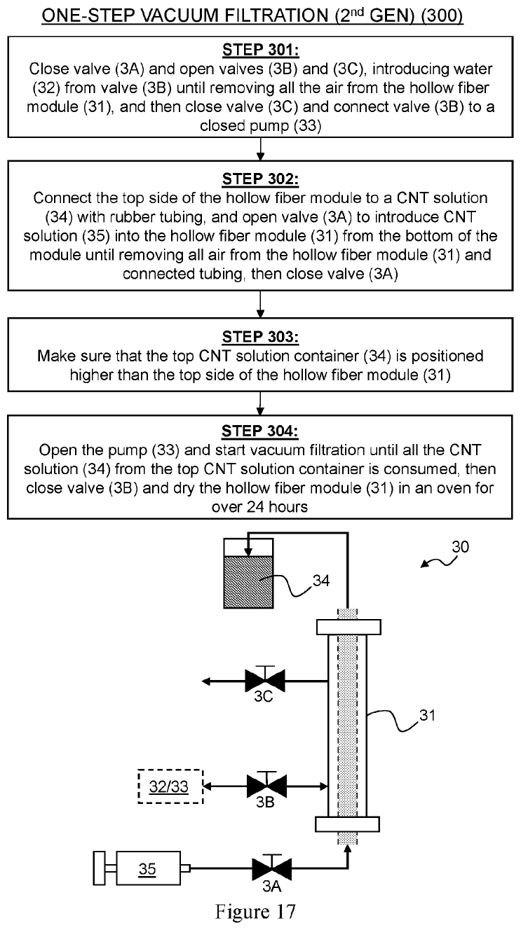

In various other examples, the CNT coating step is performed via a “one-step vacuum filtration” method. See FIG. 9. For example, in this method, the porous substrate (e.g., hollow fiber) is oriented vertically having a CNT mixture in fluid connection with the bottom of the porous substrate and a CNT mixture in fluid connection with the top of the porous substrate. The fluid connection of the CNT mixture at the bottom of the porous substrate can be opened or closed via a valve. The CNT mixture in fluid connection with the top of the porous substrate (e.g., hollow fiber) is spatially above the porous substrate (e.g., hollow fiber). The CNT mixture in fluid connection with the bottom of the porous substrate is first contacted with the porous substrate (e.g., hollow fiber). Following that, the CNT mixture in fluid connection with the top of the porous substrate (e.g., hollow fiber) is then contacted with the porous substrate (e.g., hollow fiber). See FIG. 9.

Applying a negative pressure may repeated. For example, applying a negative pressure may be repeated one or more times. In various other examples, applying a negative pressure is performed once and is not repeated.

Following application of negative pressure, a mixture (e.g., reaction mixture) comprising CO₂-philic components and quantum dots is contacted with the porous substrate. In various examples, the porous substrate is a hollow fiber. The hollow interior of the hollow fiber may be filled with the mixture (e.g., reaction mixture) comprising CO₂-philic components and quantum dots. In various other examples, any portion of a surface or all of a surface of the substrate or all surfaces of the substrate are contacted with the mixture (e.g., reaction mixture) comprising CO₂-philic components and quantum dots.

Following contacting of the mixture comprising CO₂-philic components and quantum dots with the porous substrate, the contacted porous substrate may be treated with heat. For example, the contacted porous substrate is heated at or about 70° C. for at or about 24 hours. After heating, the CO₂-philic components and quantum dots are immobilized in the carbon nanotube mesh.

In an aspect, the present disclosure provides a method for using an article and/or membrane of the present disclosure. An article and/or membrane may be used to capture CO₂ and/or N₂ gas.

A method of using may comprise contact a gas with an article or membrane of the present disclosure. The gas may be or comprise CO₂ and/or N₂. In various examples, the article or membrane has a selectivity to selectively capture CO₂ rather than other gases. For example, the gas may be a gas stream. The gas stream may be power plant flue gas. For example, a method of the present disclosure may be used to capture 50 to 60% of the CO₂ found in power plant flue gas. The captured CO₂ may have a purity of or around 95%. In various examples, a membrane or article of the present disclosure may capture 50 to 97% of CO₂ in a gas sample (e.g., gas stream comprising CO₂).

The steps of the method described in the various embodiments and examples disclosed herein are sufficient to carry out the methods of the present invention. Thus, in an embodiment, the method consists essentially of a combination of the steps of the methods disclosed herein. In another embodiment, the method consists of such steps.

The following Statements are not intended to be limiting in any manner.

Statement 1. An article or membrane for CO₂ and/or N₂ capture comprising a porous substrate having a plurality of carbon nanotubes disposed thereon, wherein the plurality of carbon nanotubes is infiltrated (e.g., coated) with (i) one or more CO₂-philic components and (ii) one or more quantum dots (e.g., N-GOQDs).

Statement 2. An article or membrane according to Statement 1, wherein the quantum dots are nitrogen-doped graphene oxide quantum dots.

Statement 3. An article or membrane according to Statement 1 or Statement 2, wherein the porous substrate is a hollow fiber.

Statement 4. An article or membrane according to any one of the preceding Statements, wherein the porous substrate is polyether sulfone (PES), polyacrylonitrile (PAN), or polyvinylidene difluoride (PVDF). In various embodiments, the porous substrate is PES.

Statement 5. An article or membrane according to any one of the preceding Statements, wherein the porous substrate has one or more pores having a diameter of 10 to 50 nm, including all 0.1 nm values and ranges therebetween.

Statement 6. An article or membrane according to any one of the preceding Statements, wherein the CO₂-philic component is an amine or derived from an ionic liquid.

Statement 7. An article according to Statement 6, wherein the ionic liquid is 1-ethyl-3-methylimidazolium acetate ([emim][Ac]), 1-ethyl-3-methylimidazolium tetrafluoroborate ([emim][BF4]), or the like, or a combination thereof.

Statement 8. An article or membrane according to Statement 6, wherein the ionic liquid is an amino acid ionic liquid.

Statement 9. An article or membrane according to Statement 8, wherein the amino acid ionic liquid is 1-ethyl-3-methylimidazolium glycinate ([emim][Gly]), [emim][Ala], [emim][Arg], [emim][Val], [emim][Lys], [emim][Pro], or the like, or any combination thereof. In various embodiments, the ionic liquid is [emim][Gly].

Statement 10. An article or membrane according to any one of the preceding Statements, wherein the plurality of carbon nanotubes are single-walled carbon nanotubes. The carbon nanotubes may have a diameter of 2 to 3 nm, including all 0.01 nm values and ranges therebetween, and have a longest linear dimension (e.g., length) of about 1 to 10 μm, including all integer nm values and ranges (e.g., the single wall carbon nanotubes may have a longest linear dimension (e.g., length) is or is about 5 μm).

Statement 11. A method of making an article or membrane according to any one of the preceding Statements, comprising: contacting a porous substrate with a plurality of carbon nanotubes; applying a negative pressure (e.g., vacuum) to the porous substrate; drying the carbon nanotube-coated porous substrate; contacting the carbon nanotube-coated porous substrate with a reaction mixture comprising a plurality of quantum dots (e.g., N-GOQDs) and one or more CO₂-philic components; and heating the carbon nanotube-coated porous substrate that has been contacted with the plurality of quantum dots and the one or more CO₂-philic components, wherein the article is formed.

Statement 12. A method according to Statement 11, wherein the contacting the substrate with a plurality of carbon nanotubes and/or applying a negative pressure to the substrate is repeated one or more times.

Statement 13. A method according to Statement 11 or Statement 12, wherein the plurality of carbon nanotubes are single-walled carbon nanotubes. The carbon nanotubes may have a diameter of 2 to 3 nm, including all 0.01 nm values and ranges therebetween, and have a longest linear dimension (e.g., length) of about 1 to 10 μm, including all integer nm values and ranges (e.g., the single wall carbon nanotubes may have a longest linear dimension (e.g., length) is or is about 5 μm).

Statement 14. A method according to any one of Statements 11-13, wherein the porous substrate is a hollow fiber.

Statement 15. A method according to any one of Statements 11-14, wherein the porous substrate is polyether sulfone (PES), polyacrylonitrile (PAN), or polyvinylidene difluoride (PVDF). In various embodiments, the porous substrate is PES.

Statement 16. A method according to any one of Statements 11-15, wherein the one or more CO₂-philic components are amines or derived from an ionic liquid.

Statement 17. A method according to Statement 16, wherein the ionic liquid is 1-ethyl-3-methylimidazolium acetate ([Emim][Ac]), 1-ethyl-3-methylimidazolium tetrafluoroborate ([Emim][BF4]), or the like, or a combination thereof.

Statement 18. A method according to any one of Statements 11-16, wherein the ionic liquid is an amino acid ionic liquid.

Statement 19. A method according to Statement 18, wherein the amino acid ionic liquid was 1-ethyl-3-methylimidazolium glycinate ([emim][Gly]), [emim][Ala], [emim][Arg], [emim][Val], [emim][Lys], [emim][Pro], or the like, or any combination thereof. In various embodiments, the ionic liquid is [emim][Gly].

Statement 20. A method according to any one of Statements 11-19, wherein the contacting the porous substrate with the plurality of carbon nanotubes is performed by circulating a mixture comprising the carbon nanotubes through the substrate.

Statement 21. A method for capturing CO₂ and/or N₂ comprising contacting an article or membrane according to any one of Statements 1 to 10 or an article or membrane made via method according to Statements 11 to 19 with a gas, wherein at least a portion of the gas is captured by the membrane.

Statement 22. A method according to Statement 20 or 22, wherein the gas is CO₂ and/or N₂.

The following examples are presented to illustrate the present disclosure. They are not intended to be limiting in any matter.

### Example 1

This example provides a description of preparing an article of the present disclosure.

The present disclosure provides i) nano-confined functional membranes fabricated by combining a nano-confined framework (single-walled carbon nanotube (SWCNT) mesh infiltrated with nitrogen-doped graphene oxide quantum dots (N-GOQD)) with CO₂-philic components and ii) scaling up technique of the nano-confined functional membranes.

SWCNT mixture was vacuum filtrated onto PES support to form a base SWCNT mesh with 5-20 nm of effective pore size. After drying process, as-prepared SWCNT/PES framework was then dip-coated into a mixture comprising N-GOQD/CO₂-phlic components, such ionic liquids, amines, etc. Upon heat treatment, N-GOQD and CO₂-phlic components were immobilized within the SWCNT mesh. This rationally designed membrane may be referred to as nano-confined functional membranes.

Described is a facile circulation coating technique for scaling up of the nano-confined functional membranes on hollow fiber support. Basically, a SWCNT mixture was circulated through the hollow fiber until all bubbles were removed from it. Then, the circulation was stopped, and vacuum was applied on the permeated side of hollow fiber module to immobilize SWCNT onto the support. After that, via repeating the SWCNT mixture circulation and vacuum filtration by multiple times, SWCNT mesh in larger scale (10 cm² to 1,000 cm²) can be applied on a larger scale.

After drying process, the SWCNT-coated hollow fiber was filled with mixture containing N-GOQD/CO₂-philic component until no air bubbles were observed. Then, the coating mixture was released out of hollow fiber and 1000 cm² nano-confined functional membrane was formed via the following heat treatment. The scale-up membrane showed the comparable gas separation performance to the small membranes. Thus, this fabrication technique enables the scaling-up of the membrane in an easy way and might be used in the practical industrial production.

### Example 2

This example provides a description of preparing an article of the present disclosure.

A second generation scaling up technique was further developed for improving CNT uniformity in large area membrane support. In this case, a hollow fiber module was filled with DI water and the openings of module to a closed vacuum pump. The top side of hollow fiber module was connected into the CNT mixture by rubber tubing. Then, a certain amount of CNT mixture was introduced into hollow fiber from bottom side by syringe pump. After removing all the air in the hollow fiber, the bottom opening of module was also sealed. Moreover, container with CNT mixture stood was kept higher than the top side of hollow fiber module. Finally, the vacuum pump was opened, and CNT was vacuum filtrated onto PES support until all the CNT mixture was consumed. After drying the CNT-coated membrane, GOQD/ionic liquid coating process was maintained as same as shown in the first generation described in Example 1.

Although the present disclosure has been described with respect to one or more particular embodiments and/or examples, it will be understood that other embodiments and/or examples of the present disclosure may be made without departing from the scope of the present disclosure.

1. A membrane for CO₂ and/or N₂ capture comprising a porous substrate having a plurality of carbon nanotubes disposed thereon, wherein at least a portion of the plurality of carbon nanotubes is infiltrated with (i) one or more CO₂-philic components and (ii) one or more quantum dots.

2. The membrane according to claim 1, wherein the quantum dots are silicon quantum dots, metal oxide quantum dots, nitrogen-doped graphene oxide quantum dots (N-GOQDs), or any combination thereof.

3. The membrane according to claim 2, wherein the quantum dots are nitrogen-doped graphene oxide quantum dots (N-GOQDs).

4. The membrane according to claim 1, wherein the porous substrate is a hollow fiber.

5. The membrane according to claim 1, wherein the porous substrate is polyether sulfone (PES), polyacrylonitrile (PAN), or polyvinylidene difluoride (PVDF).

6. The membrane according to claim 1, wherein the porous substrate is polyether sulfone (PES).

7. The membrane according to claim 1, wherein the porous substrate has one or more pores having a diameter of 10 to 50 nm.

8. The membrane according to claim 1, wherein the one or more CO₂-philic components are amines or derived from an ionic liquid.

9. The membrane according to claim 8, wherein the ionic liquid is 1-ethyl-3-methylimidazolium acetate ([emim][Ac]), 1-ethyl-3-methylimidazolium tetrafluoroborate ([emim][BF4]), or a combination thereof.

10. The membrane according to claim 8, wherein the ionic liquid is an amino acid ionic liquid.

11. The membrane according to claim 10, wherein the amino acid ionic liquid is [emim][Gly], [emim][Ala], [emim][Arg], [emim][Val], [emim][Lys], [emim][Pro], or any combination thereof.

12. The membrane according to claim 10, wherein the amino acid ionic liquid is [emim][Gly].

13. The membrane according to claim 1, wherein the plurality of carbon nanotubes are single-walled carbon nanotubes.

14. A method of making a membrane according to claim 1, comprising
contacting a porous substrate with a plurality of carbon nanotubes;
applying a negative pressure to the porous substrate;
drying the carbon nanotube-coated porous substrate;
contacting the carbon nanotube-coated porous substrate with a reaction mixture comprising a plurality of quantum dots and one or more CO₂-philic components; and
heating the carbon nanotube-coated porous substrate that has been contacted with the plurality of quantum dots and the one or more CO₂-philic components, wherein the membrane is formed.

15. The method according to claim 14, wherein the contacting the substrate with a plurality of carbon nanotubes and/or applying a negative pressure to the substrate is repeated one or more times.

16. The method according to claim 14, wherein the plurality of carbon nanotubes are single-walled carbon nanotubes.

17. The method according to claim 14, wherein the porous substrate is a hollow fiber.

18. The method according to claim 14, wherein the porous substrate is polyether sulfone (PES), polyacrylonitrile (PAN), or polyvinylidene difluoride (PVDF).

19. The method according to claim 18, wherein the porous substrate is polyether sulfone (PES).

20. The method according to claim 14, wherein the one or more CO₂-philic components are amines or derived from an ionic liquid.

21. The method according to claim 20, wherein the ionic liquid is 1-ethyl-3-methylimidazolium acetate ([emim][Ac]), 1-ethyl-3-methylimidazolium tetrafluoroborate ([emim][BF4]), or a combination thereof.

22. The method according to claim 20, wherein the ionic liquid is an amino acid ionic liquid.

23. The method according to claim 22, wherein the amino acid ionic liquid is ([emim][Gly]), [emim][Ala], [emim][Arg], [emim][Val], [emim][Lys], [emim][Pro], or any combination thereof.

24. The method according to claim 14, wherein the contacting the porous substrate with the plurality of carbon nanotubes is performed by circulating a mixture comprising the carbon nanotubes through the substrate.

25. A method for capturing a gas comprising contacting a membrane of claim 1 with the gas, wherein the membrane captures at least a portion of the gas is captured.

26. The method of claim 25, wherein the gas is CO₂ and/or N₂.

27. An article of manufacture comprising a membrane of claim 1.
